(19) United States
(12) Patent Application Publication
(10) Pub. No.: US 2026/0357390 A1
(43) Pub. Date: Nov. 12, 2026

(54) NON-ORIENTED ELECTRICAL STEEL SHEET AND METHOD FOR MANUFACTURING SAME

(71) Applicant: HYUNDAI STEEL COMPANY, Incheon (KR)

(72) Inventors: Min Sung Kim, Gyeonggi-Do (KR); Won Kee Chae, Daejeon (KR); Jong Min Jeong, Jeonbuk-Do (KR)

(21) Appl. No.: 19/722,429

(22) Filed: Jun. 26, 2026

Related U.S. Application Data
(63) Continuation of application No. PCT/KR2024/021184, filed on Dec. 26, 2024.

(30) Foreign Application Priority Data
Dec. 29, 2023 (KR) 10-2023-0197953

(51) Int. Cl. C22C 38/02; C21D 6/00; C21D 8/1216; C21D 8/1244; C21D 9/46; C22C 38/00; C22C 38/04; C22C 38/06; C22C 38/14; H01F 1/147

(52) U.S. Cl. CPC C22C 38/02; C21D 6/005; C21D 6/008; C21D 8/1222; C21D 8/1233; C21D 8/1261; C21D 9/46; C22C 38/001; C22C 38/002; C22C 38/004; C22C 38/005; C22C 38/04; C22C 38/06; C22C 38/14; H01F 1/14791; C22C 2202/02

(57) ABSTRACT

In one aspect, the present disclosure relates to a non-oriented electrical steel sheet and a method for manufacturing same. According to the non-oriented electrical steel sheet and the method for manufacturing same of the present application, the non-oriented electrical steel sheet can possess excellent magnetic properties through texture improvement.

### CROSS-REFERENCE TO THE RELATED APPLICATIONS

This application is a continuation of International Application No. PCT/KR2024/021184 filed Dec. 26, 2024, which claims the benefit of Korean Patent Application No. 10-2023-0197953, filed Dec. 29, 2023, in the Ministry of Intellectual Property, the entire contents of which applications are incorporated herein by reference.

### TECHNICAL FIELD

The present disclosure relates to a non-oriented electrical steel sheet and a method for manufacturing the same.

### BACKGROUND

Recently, driven by policies aimed at reducing CO₂ emissions to prevent global warming, traditional internal combustion engine vehicles are being rapidly replaced by eco-friendly vehicles, such as hybrid electric vehicles (HEVs) or, in particular, electric vehicles (EVs). These electric vehicles (EVs) are required to produce high torque at low speeds or during acceleration, and perform high-speed rotation at or above 200 Hz during constant-speed and high-speed driving. For this reason, non-oriented electrical steel sheets, which are the iron core material for motors, must simultaneously satisfy high magnetic flux density and low iron loss.

Factors affecting the magnetic properties of such non-oriented electrical steel sheets include chemical composition, thickness of the non-oriented electrical steel sheet, microstructure, insulating coating layers, crystallographic texture, and the like. These various factors are influenced by the manufacturing process conditions for the non-oriented electrical steel sheets. In general, non-oriented electrical steel sheets are manufactured through processes of steelmaking/continuous casting, hot rolling, pre-annealing, cold rolling, final annealing, and coating, and can have excellent magnetic properties by optimizing each process condition.

Of these, crystallographic texture is one of the important factors for improving iron loss and magnetic flux density. In terms of crystallographic texture, the <100> orientation is an orientation in which magnetization occurs easily, whereas the <111> orientation is an orientation unfavorable for magnetization. Magnetization is determined by the processes of magnetic domain wall motion and magnetic domain rotation, and higher magnetic flux density and lower iron loss are obtained when a greater abundance of orientations favorable for magnetization and fewer orientations unfavorable for magnetization are present in a sample. Due to this magnetocrystalline anisotropy, the magnetic flux density and iron loss in non-oriented electrical steel sheets are heavily dependent upon their crystallographic texture.

Therefore, there is a need for a non-oriented electrical steel sheet and a method of manufacturing the same to solve these problems.

### SUMMARY

In one aspect, it is an object of the present disclosure to provide a non-oriented electrical steel sheet having excellent magnetic properties by improving crystallographic texture, and a method of manufacturing the same.

In order to achieve the above object, a non-oriented electrical steel sheet of the present disclosure contains, in weight percent: Si at 1.8% or greater and 3.8% or less; Mn at 0.2% or greater and 0.4% or less; Al at 0.8% or greater and 1.5% or less; B at greater than 0% and less than 0.02%; and Ce at greater than 0% and less than 0.02%, with the balance being Fe and unavoidable impurities, and satisfies General Formula 1 below.

$$5 \leq \frac{1.5 \times a + 3 \times b}{0.5 \times c} . \qquad [ General Formula 1 ]$$

The above weight percents are based on total weight of the steel sheet material. Unless otherwise indicated, weight percent of a component are in reference to or based on total weight of the sheet or other material.

In General Formula 1 above, a is a maximum intensity (f(g)ₘₐₓ) of an orientation distribution function in a crystallographic texture appearing at Euler angles (φ₁, Φ, φ₂) where φ₁ is 15° or greater and 35° or less, Φ is 0° or greater and 35° or less, and φ₂ is 45°, b is a maximum intensity (f(g)ₘₐₓ) of an orientation distribution function in a crystallographic texture appearing at Euler angles (φ₁, Φ, φ₂) where φ₁ is 55° or greater and 75° or less, Φ is 0° or greater and 20° or less, and φ₂ is 45°, and c is a maximum intensity (f(g)ₘₐₓ) of an orientation distribution function in a crystallographic texture appearing at Euler angles (φ₁, Φ, φ₂) where φ₁ is 15° or greater and 35° or less, Φ is greater than 35° and 60° or less, and φ₂ is 45°.

The maximum intensity (f(g)ₘₐₓ) of the orientation distribution function in the crystallographic texture appearing at Euler angles (φ₁, Φ, φ₂) where φ₁ is 15° or greater and 35° or less, Φ is 0° or greater and 35° or less, and φ₂ is 45° may be 4.4 or greater and 7.0 or less.

In addition, an orientation (g) of the crystallographic texture having the maximum intensity (f(g)ₘₐₓ) of the orientation distribution function in the crystallographic texture appearing at Euler angles (φ₁, Φ, φ₂) where φ₁ is 15° or greater and 35° or less, Φ is 0° or greater and 35° or less, and φ₂ is 45° may be a {113}<251> orientation.

In addition, the maximum intensity (f(g)ₘₐₓ) of the orientation distribution function in the crystallographic texture appearing at Euler angles (φ₁, Φ, φ₂) where φ₁ is 55° or greater and 75° or less, Φ is 0° or greater and 20° or less, and φ₂ is 45° may be 3.0 or greater and 7.0 or less.

In addition, an orientation (g) of the crystallographic texture having the maximum intensity (f(g)ₘₐₓ) of the orientation distribution function in the crystallographic texture appearing at Euler angles (φ₁, Φ, φ₂) where φ₁ is 55° or greater and 75° or less, Φ is 0° or greater and 20° or less, and φ₂ is 45° may be a {100}<130> orientation.

In addition, the maximum intensity (f(g)ₘₐₓ) of the orientation distribution function in the crystallographic texture appearing at Euler angles (φ₁, Φ, φ₂) where φ₁ is 15° or greater and 35° or less, Φ is greater than 35° and 60° or less, and φ₂ is 45° may be 3.0 or greater and 8.5 or less.

In addition, an orientation (g) of the crystallographic texture having the maximum intensity (f(g)ₘₐₓ) of the orientation distribution function in the crystallographic texture appearing at Euler angles (φ₁, Φ, φ₂) where φ₁ is 15° or greater and 35° or less, Φ is greater than 35° and 60° or less, and φ₂ is 45° may be a {334}<483> orientation.

In addition, the non-oriented electrical steel sheet may have a total content of B and Ce of greater than 0% and 0.02% or less by weight.

In addition, the non-oriented electrical steel sheet may further contain one or more selected from: C at greater than 0% and 0.002% or less; P at greater than 0% and 0.015% or less; S at greater than 0% and 0.002% or less; N at greater than 0% and 0.002% or less; and Ti at greater than 0% and 0.002% or less, in weight percent.

In addition, the non-oriented electrical steel sheet may have an average of iron loss W_{10/400} of 13.00 W/kg or less and an average of magnetic flux density (B₅₀) of 1.64 T or greater measured at angles of 0° and 90° with respect to a rolling direction during cold rolling.

In addition, a method of manufacturing a non-oriented electrical steel sheet of the present disclosure comprises the steps of: reheating and then hot-rolling a slab containing, in weight percent: Si at 1.8% or greater and 3.8% or less; Mn at 0.2% or greater and 0.4% or less; Al at 0.8% or greater and 1.5% or less; B at greater than 0% and less than 0.02%; and Ce at greater than 0% and less than 0.02%, with the balance being Fe and unavoidable impurities; manufacturing a cold-rolled steel sheet by cold-rolling; and final annealing the cold-rolled steel sheet, wherein the final annealed steel sheet satisfies General Formula 1 below.

$$5 \leq \frac{1.5 \times a + 3 \times b}{0.5 \times c} \qquad [ General Formula 1 ]$$

In General Formula 1 above, a is a maximum intensity (f(g)ₘₐₓ) of an orientation distribution function in a crystallographic texture appearing at Euler angles (φ₁, Φ, φ₂) where φ₁ is 15° or greater and 35° or less, Φ is 0° or greater and 35° or less, and φ₂ is 45°, b is a maximum intensity (f(g)ₘₐₓ) of an orientation distribution function in a crystallographic texture appearing at Euler angles (φ₁, Φ, φ₂) where φ₁ is 55° or greater and 75° or less, Φ is 0° or greater and 20° or less, and φ₂ is 45°, and c is a maximum intensity (f(g)ₘₐₓ) of an orientation distribution function in a crystallographic texture appearing at Euler angles (φ₁, Φ, φ₂) where φ₁ is 15° or greater and 35° or less, Φ is greater than 35° and 60° or less, and φ₂ is 45°.

In addition, the maximum intensity (f(g)ₘₐₓ) of the orientation distribution function in the crystallographic texture appearing at Euler angles (φ₁, Φ, φ₂) where φ₁ is 15° or greater and 35° or less, Φ is 0° or greater and 35° or less, and φ₂ is 45° in the final annealed steel sheet may be 4.4 or greater and 7.0 or less.

In addition, the maximum intensity (f(g)ₘₐₓ) of the orientation distribution function in the crystallographic texture appearing at Euler angles (φ₁, Φ, φ₂) where φ₁ is 55° or greater and 75° or less, Φ is 0° or greater and 20° or less, and φ₂ is 45° in the final annealed steel sheet may be 3.0 or greater and 7.0 or less.

In addition, the maximum intensity (f(g)ₘₐₓ) of the orientation distribution function in the crystallographic texture appearing at Euler angles (φ₁, Φ, φ₂) where φ₁ is 15° or greater and 35° or less, Φ is greater than 35° and 60° or less, and φ₂ is 45° in the final annealed steel sheet may be 3.0 or greater and 8.5 or less.

In addition, the slab may have a total content of B and Ce of greater than 0% and 0.02% or less in weight percent.

In addition, the slab may further contain one or more selected from: C at greater than 0% and 0.002% or less; P at greater than 0% and 0.015% or less; S at greater than 0% and 0.002% or less; N at greater than 0% and 0.002% or less; and Ti at greater than 0% and 0.002% or less, in weight percent.

In addition, the method of manufacturing a non-oriented electrical steel sheet may further include a step of pre-annealing the hot-rolled steel sheet that has been hot-rolled through the step of hot-rolling, wherein the step of pre-annealing may be performed by heating the hot-rolled steel sheet to 900 °C or greater and 1100 °C or less at a heating rate of 20 °C/s or greater.

In addition, the hot-rolled steel sheet may have an average grain size of 100 μm or greater and 250 μm or less during the pre-annealing process.

In a further aspect, vehicles (including electric-powered vehicles) are provided that comprise a non-oriented electrical steel sheet as disclosed herein. In a further aspect, electric car driving motors are provided that comprise a non-oriented electrical steel sheet as disclosed herein. It is understood that the term “vehicle” or “vehicular” or other similar term as used herein is inclusive of motor vehicles in general such as passenger automobiles comprising sports utility vehicles (SUV), buses, trucks, various commercial vehicles, watercraft comprising a variety of boats and ships, aircraft, and the like, and comprises hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

According to the non-oriented electrical steel sheet and the method of manufacturing the same of the present application, excellent magnetic properties can be achieved by improving crystallographic texture.

### DETAILED DESCRIPTION

In one aspect, the present disclosure relates to a non-oriented electrical steel sheet, which is an iron core material used in motors that convert electrical energy into mechanical energy. The non-oriented electrical steel sheet contains, in weight percent: Si at 1.8% or greater and 3.8% or less; Mn at 0.2% or greater and 0.4% or less; Al at 0.8% or greater and 1.5% or less; B at greater than 0% and less than 0.02%; and Ce at greater than 0% and less than 0.02%, with the balance being Fe and unavoidable impurities, and satisfies General Formula 1 below.

$$5 \leq \frac{1.5 \times a + 3 \times b}{0.5 \times c} . \qquad [ General Formula 1 ]$$

In General Formula 1 above, a is the maximum intensity (f(g)ₘₐₓ) of the orientation distribution function in the crystallographic texture appearing at Euler angles (φ₁, Φ, φ₂) where φ₁ is 15° or greater and 35° or less, Φ is 0° or greater and 35° or less, and φ₂ is 45°, b is the maximum intensity (f(g)ₘₐₓ) of the orientation distribution function in the crystallographic texture appearing at Euler angles (φ₁, Φ, φ₂) where φ₁ is 55° or greater and 75° or less, Φ is 0° or greater and 20° or less, and φ₂ is 45°, and c is the maximum intensity (f(g)ₘₐₓ) of the orientation distribution function in the crystallographic texture appearing at Euler angles (φ₁, Φ, φ₂) where φ₁ is 15° or greater and 35° or less, Φ is greater than 35° and 60° or less, and φ₂ is 45°.

Specifically, the value calculated by General Formula 1 above may be 5.2 or greater, or 5.4 or greater. Further, the upper limit of the value calculated by General Formula 1 above may be 15 or less, 14 or less, or 13 or less. By satisfying the aforementioned General Formula 1, the non-oriented electrical steel sheet can exhibit excellent magnetic properties, specifically, low iron loss and high magnetic flux density. In this case, the intensity (f(g)) of the orientation distribution function refers to the relative intensity based on an intensity of 1 for a disordered texture devoid of any crystallographic texture. For example, the maximum intensity (f(g)ₘₐₓ) of the orientation distribution function refers to the maximum intensity among the intensities of orientations of the crystallographic texture present within the aforementioned angular ranges of φ₁ and Φ, as shown on the cross-section of the orientation distribution function (ODF) at φ₂ is 45°.

In one example, the maximum intensity (f(g)ₘₐₓ) of the orientation distribution function in the crystallographic texture appearing at Euler angles (φ₁, Φ, φ₂) where φ₁ is 15° or greater and 35° or less, Φ is 0° or greater and 35° or less, and φ₂ is 45° may be 4.4 or greater and 7.0 or less. Specifically, the maximum intensity (f(g)ₘₐₓ) of the orientation distribution function in the crystallographic texture appearing at the aforementioned Euler angles may be 4.4 or greater and 6.8 or less, 4.4 or greater and 6.5 or less, or 4.4 or greater and 6.3 or less. By satisfying General Formula 1 above and by ensuring that the maximum intensity (f(g)ₘₐₓ) of the orientation distribution function in the crystallographic texture appearing at the aforementioned Euler angles satisfies the aforementioned range, the non-oriented electrical steel sheet can exhibit excellent magnetic properties, specifically, high magnetic flux density and low iron loss.

For example, the orientation (g) of the crystallographic texture having the maximum intensity (f(g)ₘₐₓ) of the orientation distribution function in the crystallographic texture appearing at Euler angles (φ₁, Φ, φ₂) where φ₁ is 15° or greater and 35° or less, Φ is 0° or greater and 35° or less, and φ₂ is 45° may be the {113}<251> orientation. That is, since the {113}<251> orientation is an orientation favorable for magnetization, and is included in the non-oriented electrical steel sheet at the aforementioned maximum intensity (f(g)ₘₐₓ) of the orientation distribution function, the non-oriented electrical steel sheet can exhibit excellent magnetic properties, specifically, high magnetic flux density and low iron loss.

In addition, the maximum intensity (f(g)ₘₐₓ) of the orientation distribution function in the crystallographic texture appearing at Euler angles (φ₁, Φ, φ₂) where φ₁ is 55° or greater and 75° or less, Φ is 0° or greater and 20° or less, and φ₂ is 45° may be 3.0 or greater and 7.0 or less. Specifically, the maximum intensity (f(g)ₘₐₓ) of the orientation distribution function in the crystallographic texture appearing at the aforementioned Euler angles may be 3.1 or greater and 6.7 or less, or 3.2 or greater and 6.5 or less. By satisfying General Formula 1 above and by ensuring that the maximum intensity (f(g)ₘₐₓ) of the orientation distribution function in the crystallographic texture appearing at the aforementioned Euler angles satisfies the aforementioned range, the non-oriented electrical steel sheet can exhibit excellent magnetic properties, specifically, high magnetic flux density and low iron loss.

For example, the orientation (g) of the crystallographic texture having the maximum intensity (f(g)ₘₐₓ) of the orientation distribution function in the crystallographic texture appearing at Euler angles (φ₁, Φ, φ₂) where φ₁ is 55° or greater and 75° or less, Φ is 0° or greater and 20° or less, and φ₂ is 45° may be the {100}<130> orientation. That is, since the {100}<130> orientation is an orientation favorable for magnetization, and is included in the non-oriented electrical steel sheet at the aforementioned maximum intensity (f(g)ₘₐₓ) of the orientation distribution function, the non-oriented electrical steel sheet can exhibit excellent magnetic properties, specifically, high magnetic flux density and low iron loss.

In addition, the maximum intensity (f(g)ₘₐₓ) of the orientation distribution function in the crystallographic texture appearing at Euler angles (φ₁, Φ, φ₂) where φ₁ is 15° or greater and 35° or less, Φ is greater than 35° and 60° or less, and φ₂ is 45° may be 3.0 or greater and 8.5 or less. Specifically, the maximum intensity (f(g)ₘₐₓ) of the orientation distribution function in the crystallographic texture appearing at the aforementioned Euler angles may be 3.2 or greater and 8.4 or less, 3.5 or greater and 8.3 or less, or 3.7 or greater and 8.2 or less. By satisfying General Formula 1 above and by ensuring that the maximum intensity (f(g)ₘₐₓ) of the orientation distribution function in the crystallographic texture appearing at the aforementioned Euler angles satisfies the aforementioned range, the non-oriented electrical steel sheet can exhibit excellent magnetic properties, specifically, high magnetic flux density and low iron loss.

For example, the orientation (g) of the crystallographic texture having the maximum intensity (f(g)ₘₐₓ) of the orientation distribution function in the crystallographic texture appearing at Euler angles (φ₁, Φ, φ₂) where φ₁ is 15° or greater and 35° or less, Φ is greater than 35° and 60° or less, and φ₂ is 45° may be the {334}<483> orientation. That is, since the {334}<483> orientation is an orientation unfavorable for magnetization, and is included in the non-oriented electrical steel sheet at the aforementioned maximum intensity (f(g)ₘₐₓ) of the orientation distribution function, the non-oriented electrical steel sheet can exhibit excellent magnetic properties, specifically, high magnetic flux density and low iron loss.

In one example, the non-oriented electrical steel sheet may have an average of iron loss W_{10/400} of 13.00 W/kg or less and an average of magnetic flux density (B₅₀) of 1.64 T or greater, measured at angles of 0° and 90° relative to the rolling direction during cold rolling. Specifically, the average of the iron loss W_{10/400} measured under the aforementioned conditions may be 12.80 W/kg or less, or 12.60 W/kg or less. For the non-oriented electrical steel sheet, from the perspective that the lower the iron loss W_{10/400}, the better the magnetic properties are, its lower limit is not particularly restricted, and from the perspective that the higher the magnetic flux density (B₅₀), the better the magnetic properties are, its upper limit is not particularly restricted, but they may be, for example, 5 W/kg or greater and 1.70 T or less, respectively. The iron loss W_{10/400} refers to the iron loss when a magnetic flux density of 1.0 T is induced at a high frequency of 400 Hz. Further, the magnetic flux density (B₅₀) refers to the magnetic flux density induced in a magnetic field of 5000 A/m. In this case, the iron loss and magnetic flux density were measured with a Single Sheet Tester after punching the non-oriented electrical steel sheet to a width of 60 mm and a length of 60 mm.

The non-oriented electrical steel sheet may have a thickness of less than 0.35 mm, specifically, of 0.1 mm or greater and less than 0.35 mm, or 0.1 mm or greater and 0.3 mm or less. By ensuring that the thickness falls within the aforementioned range, the non-oriented electrical steel sheet can exhibit excellent iron loss as eddy current loss is reduced.

In one example, the non-oriented electrical steel sheet may further include a coating layer on its surface. The coating layer is an insulating coating layer formed on the surface of the non-oriented electrical steel sheet, and may be referred to as an insulating film. Since the insulating film is widely known, a detailed description thereof will be omitted. For example, the coating layer may be formed by applying a chromate-based coating solution, or a chromium-free (Cr-free) coating solution, which is an organic-inorganic composite coating solution containing no chromium, to the surface of the final annealed steel sheet, and then baking it. In this case, the thickness of the coating layer may be 0.1 μm or greater and 5 μm or less. By further including the aforementioned coating layer on its surface, the non-oriented electrical steel sheet can reduce eddy current loss by maintaining electrical insulation between the upper and lower non-oriented electrical steel sheets when the non-oriented electrical steel sheets are stacked in a plurality.

The components of the non-oriented electrical steel sheet will be described below.

### Si: 1.8 wt % or Greater and 3.8 wt % or Less

Silicon (Si) is an element that reduces eddy current loss by increasing the electrical resistivity of the material. If the silicon is contained in the non-oriented electrical steel sheet in an amount below the lower limit of the aforementioned range, the effect of reducing iron loss may be insufficient. In addition, if the silicon is contained in the non-oriented electrical steel sheet in an amount exceeding the upper limit of the aforementioned range, magnetic permeability and magnetic flux density may decrease. In contrast, by containing the silicon in the non-oriented electrical steel sheet in an amount of 1.8 wt % or greater and 3.8 wt % or less, the crystallographic texture can be improved even if a low content of silicon is added, and consequently, a low iron loss value similar to that achievable when adding a high content of silicon can be obtained. Specifically, the silicon can be contained in the non-oriented electrical steel sheet in an amount of 2.4 wt % or greater and 3.5 wt % or less, or 3.0 wt % or greater and 3.3 wt % or less.

### Mn: 0.2 wt % or Greater and 0.4 wt % or Less

Manganese (Mn) is an element that, together with Si, reduces iron loss by increasing electrical resistivity and improves the crystallographic texture. If the manganese is contained in the non-oriented electrical steel sheet in an amount below the lower limit of the aforementioned range, fine MnS may precipitate, thereby inhibiting grain growth and increasing iron loss. Further, if the manganese is contained in the non-oriented electrical steel sheet in an amount exceeding the upper limit of the aforementioned range, coarse MnS may precipitate, leading to a decrease in magnetic flux density, and the reduction in iron loss may be rather small relative to the amount added, thereby deteriorating cold-rolling workability. Therefore, the manganese can be contained in the non-oriented electrical steel sheet in an amount of 0.2 wt % or greater and 0.4 wt % or less, and specifically, in an amount of 0.2 wt % or greater and 0.3 wt % or less.

### Al: 0.8 wt % or Greater and 1.5 wt % or Less

Aluminum (Al) is an element that, together with the Si, reduces eddy current loss by increasing electrical resistivity, and induces the precipitation of AlN by reacting with nitrogen (N). If the aluminum is contained in the non-oriented electrical steel sheet in an amount below the lower limit of the aforementioned range, iron loss may increase due to insufficient electrical resistivity. Further, if the aluminum is contained in the non-oriented electrical steel sheet in an amount exceeding the upper limit of the aforementioned range, cold rolling workability may deteriorate, and magnetic flux density may decrease. Therefore, the aluminum can be contained in the non-oriented electrical steel sheet in an amount of 0.8 wt % or greater and 1.5 wt % or less, and specifically, in an amount of 0.9 wt % or greater and 1.0 wt % or less.

B: Greater than 0 wt % and Less than 0.02 wt %

Boron (B) is an element that lowers grain boundary energy through grain boundary segregation, reduces the volume fraction of orientations unfavorable for magnetic properties by suppressing the nucleation of the {111} and {112} orientations as the recrystallization rate decreases, and increases the {100} orientation and Goss orientation, which are favorable for magnetic properties. Specifically, the boron is an element that segregates to reduce the strain (E), which arises from lattice contraction caused by C and/or N that are interstitial solid-solution elements or from lattice expansion caused by atoms such as interstitial elements, thereby lowering the elastic energy within the lattice. The boron segregates to lower the energy of grain boundaries with high interfacial energy through recrystallization, thereby creating a stable state. The orientations favorable for nucleation may be the {111} and {112} orientations. If segregation results in a state where interfacial energy is reduced, the likelihood of nucleation in the {111} and {112} orientations decreases, whereas the likelihood of nucleation in other orientations increases, and thus, nucleation in the {111} and {112} orientations may be relatively suppressed. Further, shear strain rather than planar strain may be applied to the material during rolling due to segregation, and in general, the {111} and {112} orientations grow first during recrystallization in a plane-strained structure, whereas nucleation in the {110} orientation or other orientations, rather than in the {111} and {112} orientations, occurs first during recrystallization in a shear-strained structure. Thus, the nucleation in the {111} and {112} orientations can be suppressed by the shear strain induced during rolling by segregation. If the boron is contained in the non-oriented electrical steel sheet in an amount greater than or equal to the upper limit of the aforementioned range, the pinning effect resulting from grain boundary segregation hinders the growth of recrystallized grains, and grain growth thus fails to occur, which instead exerts an adverse effect on the crystallographic texture. Therefore, the boron can be contained in the non-oriented electrical steel sheet in an amount of greater than 0 wt % and less than 0.02 wt %, specifically, in an amount of 0.001 wt % or greater and 0.016 wt % or less, or 0.002 wt % or greater and 0.012 wt % or less.

Ce: Greater than 0 wt % and Less than 0.02 wt %

Cerium (Ce) is an element that lowers grain boundary energy through grain boundary segregation, reduces the volume fraction of orientations unfavorable for magnetic properties by suppressing the nucleation of the {111} and {112} orientations as the recrystallization rate decreases, and increases the {100} orientation and Goss orientation, which are favorable for magnetic properties. If the cerium is contained in the non-oriented electrical steel sheet in an amount greater than or equal to the upper limit of the aforementioned range, the pinning effect resulting from grain boundary segregation hinders the growth of recrystallized grains, and grain growth thus fails to occur, which instead exerts an adverse effect on the crystallographic texture. Therefore, the cerium can be contained in the non-oriented electrical steel sheet in an amount of greater than 0 wt % and less than 0.02 wt %, specifically, in an amount of 0.0005 wt % or greater and 0.018 wt % or less, or 0.001 wt % or greater and 0.015 wt % or less.

### The Balance Fe and Other Unavoidable Impurities

The unavoidable impurities are impurities introduced during the steelmaking and manufacturing processes of the non-oriented electrical steel sheet, and since these are widely known in the art, detailed descriptions thereof will be omitted. In one embodiment of the present application, the addition of elements other than the aforementioned components of the non-oriented electrical steel sheet is not precluded, and such elements may be contained in various ways within a scope that does not compromise the technical concept of the present application. If additional elements are further contained, they may be contained in place of the balance iron (Fe).

For example, the unavoidable impurities may be niobium (Nb), copper (Cu), or the like, and the non-oriented electrical steel sheet may contain Nb in an amount of less than 0.001 wt % and/or Cu in an amount of less than 0.001 wt %.

In one example, the non-oriented electrical steel sheet may have a total content of the boron (B) and cerium (Ce) of greater than 0% and 0.02% or less by weight. Specifically, the total content of the boron (B) and cerium (Ce) may be 0.001 wt % or greater and 0.02 wt % or less, 0.002 wt % or greater and 0.02 wt % or less, or 0.003 wt % or greater and 0.02 wt % or less. If the total content of the boron and cerium contained in the non-oriented electrical steel sheet exceeds the upper limit of the aforementioned range, the pinning effect resulting from grain boundary segregation hinders the growth of recrystallized grains, and grain growth thus fails to occur, which instead exerts an adverse effect on the crystallographic texture. In contrast, by ensuring that the total content of the boron and cerium contained in the non-oriented electrical steel sheet satisfies the aforementioned range, the aforementioned General Formula 1 can be satisfied, and as a result, excellent magnetic properties, specifically, low iron loss and high magnetic flux density, can be exhibited. That is, by ensuring that the total content of the boron and cerium contained in the non-oriented electrical steel sheet satisfies the aforementioned range and simultaneously ensuring that each content satisfies the aforementioned ranges, General Formula 1 above can be satisfied.

In another example, the non-oriented electrical steel sheet may further contain one or more selected from: C at greater than 0% and 0.002% or less; P at greater than 0% and 0.015% or less; S at greater than 0% and 0.002% or less; N at greater than 0% and 0.002% or less; and Ti at greater than 0% and 0.002% or less, in weight percent (wt %).

C: Greater than 0 wt % and 0.002 wt % or Less

Carbon (C) is an element that can form carbides such as TiC and/or NbC by combining with other unavoidable impurities and can increase iron loss. If the carbon is contained in the non-oriented electrical steel sheet in an amount exceeding the upper limit of the aforementioned range, it may induce magnetic aging and adversely affect the magnetic properties. Therefore, the carbon can be contained in the non-oriented electrical steel sheet in an amount of greater than 0 wt % and 0.002 wt % or less, and specifically, in an amount of 0.001 wt % or greater and 0.002 wt % or less.

P: Greater than 0 wt % and 0.015 wt % or Less

Phosphorus (P) is a grain boundary segregation element and an element that develops crystallographic texture. If the phosphorus is contained in the non-oriented electrical steel sheet in an amount exceeding the upper limit of the aforementioned range, grain growth may be inhibited due to segregation effects, magnetic properties may deteriorate, and cold rolling workability may decrease. Therefore, the phosphorus can be contained in the non-oriented electrical steel sheet in an amount of greater than 0 wt % and 0.015 wt % or less, and specifically, in an amount of 0.005 wt % or greater and 0.010 wt % or less.

S: Greater than 0 wt % and 0.002 wt % or Less

Sulfur(S) is an element that combines with other unavoidable impurities and forms sulfides such as MnS and/or CuS, and if contained in an amount exceeding the upper limit of the aforementioned range, it may increase iron loss and inhibit grain growth. Therefore, the sulfur can be contained in the non-oriented electrical steel sheet in an amount of greater than 0 wt % and 0.002 wt % or less, and specifically, in an amount of 0.001 wt % or greater and 0.002 wt % or less.

N: Greater than 0 wt % and 0.002 wt % or Less

Nitrogen (N) is an element that combines with other unavoidable impurities and forms nitrides such as AlN, TiN, and/or NbN, and if contained in an amount exceeding the upper limit of the aforementioned range, it may increase iron loss and inhibit grain growth. Therefore, the nitrogen can be contained in the non-oriented electrical steel sheet in an amount of greater than 0 wt % and 0.002 wt % or less, and specifically, in an amount of 0.001 wt % or greater and 0.0015 wt % or less.

Ti: Greater than 0 wt % and 0.002 wt % or Less

Titanium (Ti) is an element that combines with other unavoidable impurities and forms fine carbides, nitrides, or the like, such as TiC and/or TiN, and if contained in an amount exceeding the upper limit of the aforementioned range, it may degrade magnetic properties by inhibiting grain growth. Therefore, the titanium can be contained in the non-oriented electrical steel sheet in an amount of greater than 0 wt % and 0.002 wt % or less, and specifically, in an amount of 0.001 wt % or greater and 0.0015 wt % or less.

The present disclosure also relates to a method of manufacturing a non-oriented electrical steel sheet. The method of manufacturing a non-oriented electrical steel sheet relates to a method of manufacturing the aforementioned non-oriented electrical steel sheet, and specific details of a non-oriented electrical steel sheet to be described below will be omitted as the content described in the non-oriented electrical steel sheet above can be applied in the same manner.

The method of manufacturing a non-oriented electrical steel sheet of the present disclosure includes a hot rolling step, a step of manufacturing a cold-rolled steel sheet, and a final annealing step, wherein the final annealed steel sheet satisfies General Formula 1 above. According to the method of manufacturing a non-oriented electrical steel sheet of the present application, the final annealed steel sheet, i.e., the manufactured non-oriented electrical steel sheet, can satisfy General Formula 1 above, and, as a result, can exhibit excellent magnetic properties, specifically, high magnetic flux density and low iron loss.

The hot rolling step is a step for manufacturing a slab into a hot-rolled steel sheet, and is performed by reheating and then hot rolling the slab. Since the composition of the slab is identical to that of the non-oriented electrical steel sheet and all details described in the non-oriented electrical steel sheet apply equally here, a description thereof will be omitted. The reheating temperature for the slab is not particularly limited, but may be, for example, 1000 °C or greater and 1200 °C or less, specifically, 1110 °C or greater and 1150 °C or less. If the reheating temperature for the slab falls below the lower limit of the aforementioned range, the rolling load may increase during the hot rolling, and if it exceeds the upper limit of the aforementioned range, precipitates such as C, S, N, or the like within the slab may re-dissolve, leading to the formation of fine precipitates in subsequent processes, which may inhibit grain growth and adversely affect magnetic properties.

In addition, the finish rolling temperature during the hot rolling may be 860 °C or greater and 900 °C or less, specifically, 880 °C or greater and 900 °C or less. Further, the hot-rolled steel sheet obtained by the hot rolling may be coiled at 550 °C or greater and 650 °C or less. The thickness of the hot-rolled steel sheet may be 1.8 mm or greater and 2.6 mm or less. If the thickness of the hot-rolled steel sheet exceeds the upper limit of the aforementioned range, the reduction ratio during cold rolling may increase, and crystallographic texture may thus be degraded. Therefore, the thickness of the hot-rolled steel sheet can be controlled to fall within the aforementioned range.

In one example, the method of manufacturing a non-oriented electrical steel sheet may further include a pre-annealing step. The pre-annealing step is a step for increasing orientations favorable for magnetic properties by annealing the hot-rolled steel sheet that has undergone the hot rolling step, and may be performed by heating the hot-rolled steel sheet to 900 °C or greater and 1100 °C or less at a heating rate of 20 °C/s or greater. Specifically, the pre-annealing step can be performed by heating the hot-rolled steel sheet to 900 °C or greater and 1100 °C or less at a heating rate of 20 °C/s or greater in a nitrogen atmosphere, holding it at this temperature range for 30 seconds or greater and 120 seconds or less, and then cooling it at a cooling rate of 30 °C/s or greater. In this case, the pre-annealing can be performed by uncoiling the coiled hot-rolled steel sheet. If the annealing temperature and heating rate during the pre-annealing of the hot-rolled steel sheet exceed the upper limits of the aforementioned ranges, it is favorable in terms of crystallographic texture as the volume fractions of the {100}<130> and {113}<251> orientations of the crystallographic texture that are favorable for magnetic properties increase, whereas the volume fraction of the {334}<483> orientation that is unfavorable for magnetic properties decreases after the cold rolling and final annealing, but since the average grain size exceeds the aforementioned range, a microstructure may be formed highly inhomogeneously after the cold rolling, and orientation colonies may form during the final annealing, which can adversely affect the magnetic properties. Further, if the annealing temperature and heating rate during the pre-annealing of the hot-rolled steel sheet fall below the lower limits of the aforementioned ranges, the volume fractions of the {100}<130> and {113}<251> orientations of the crystallographic texture that are favorable for magnetic properties decrease, whereas the volume fraction of the {334}<483> orientation that is unfavorable for magnetic properties increases after the cold rolling and final annealing, and thus, the final product fails to satisfy General Formula 1, which may adversely affect the magnetic properties. In addition, if the holding time during the pre-annealing of the hot-rolled steel sheet falls below the lower limit of the aforementioned range, non-uniform grain growth may occur, which may adversely affect the magnetic properties of the final product.

The hot-rolled steel sheet may have an average grain size of 100 μm or greater and 250 μm or less during the pre-annealing process, and the deformation texture formed during the preceding hot rolling step can be recrystallized completely, i.e., 99% or greater. By having an average grain size within the aforementioned range during the pre-annealing process, the hot-rolled steel sheet allows the non-oriented electrical steel sheet manufactured through the final annealing to satisfy General Formula 1 above, and as a result, can enhance the magnetic properties. In contrast, if the average grain size during the pre-annealing process of the hot-rolled steel sheet falls below the lower limit of the aforementioned range, the volume fractions of the {100}<130> and {113}<251> orientations of the crystallographic texture that are favorable for magnetic properties decrease, whereas the volume fraction of the {334}<483> orientation that is unfavorable for magnetic properties increases after the cold rolling and final annealing, and thus, the final product fails to satisfy General Formula 1, which may adversely affect the magnetic properties. Further, if the average grain size during the pre-annealing process of the hot-rolled steel sheet exceeds the upper limit of the aforementioned range, it is favorable in terms of crystallographic texture as the volume fractions of the {100}<130> and {113}<251> orientations of the crystallographic texture that are favorable for magnetic properties increase, whereas the volume fraction of the {334}<483> orientation that is unfavorable for magnetic properties decreases after the cold rolling and final annealing, but since the average grain size exceeds the aforementioned range, a microstructure may be formed highly inhomogeneously after the cold rolling, and orientation colonies may form during the final annealing, which can adversely affect the magnetic properties.

Thereafter, the annealed hot-rolled steel sheet may further undergo pickling to remove the oxide layer formed on its surface via a pickling solution.

The step of manufacturing the cold-rolled steel sheet is a step for manufacturing the hot-rolled steel sheet into a cold-rolled steel sheet, and is performed through cold rolling. The reduction ratio during the cold rolling may be 80% or greater and 90% or less. The thickness of the cold-rolled steel sheet may be 0.1 mm or greater and 0.5 mm or less, specifically, 0.2 mm or greater and 0.5 mm or less.

The final annealing step is a step for ensuring magnetic properties by growing grains to a particular size, and is performed by heat-treating the cold-rolled steel sheet. For example, the final annealing can be performed by heating to 900 °C to 1100 °C at a heating rate of 10 °C/s or greater, heat-treating in this temperature range for 5 to 70 seconds, and then cooling at a cooling rate of 20 °C/s or greater. By having the final annealing step performed in the aforementioned ranges of heating rate, temperature, duration, and cooling rate, iron loss can be reduced, and an optimal grain size that takes mechanical properties into account can be derived. In contrast, if the heating rate, temperature, and duration in the final annealing step exceed the upper limits of the aforementioned ranges, the grain size may become coarser, thereby causing an increase in eddy current loss. Further, if the heating rate, temperature, and duration in the final annealing step fall below the lower limits of the aforementioned ranges, the grain size may become finer, thereby causing an increase in hysteresis loss.

In this case, the final annealing step can be performed in an atmosphere of 10% to 100% hydrogen and 0% to 90% nitrogen, specifically, 20% to 40% hydrogen and 60% to 80% nitrogen. By having the final annealing step performed under the atmosphere within the aforementioned ranges, the method of manufacturing a non-oriented electrical steel sheet allows the surface condition of the steel sheet to be smoother.

For the non-oriented electrical steel sheet, the average grain size can be 80 μm or greater and 160 μm or less in the final annealing process, and the deformation texture formed in the preceding cold rolling step can be recrystallized completely, i.e., 99% or greater. For the non-oriented electrical steel sheet, if the average grain size in the final annealing process falls below the lower limit of the aforementioned range, hysteresis loss may increase due to the fine grain size, and further, if it exceeds the upper limit of the aforementioned range, eddy current loss may increase, thereby causing an increase in iron loss.

In another example, the method of manufacturing a non-oriented electrical steel sheet may further include a step of forming a coating layer to enhance punchability and ensure electrical insulation. Specifically, the step of forming the coating layer is a step of forming a coating layer to impart electrical insulation to the surface of the final annealed steel sheet, and is performed after the final annealing step. For example, the coating layer may be formed by applying a chromate-based coating solution, or a chromium-free (Cr-free) coating solution, which is an organic-inorganic composite coating solution containing no chromium, to the surface of the final annealed steel sheet, and then baking it. In this case, the coating layer may be formed to a thickness of 0.1 μm or greater and 5 μm or less. By further including the step of forming the coating layer, the method of manufacturing a non-oriented electrical steel sheet can reduce eddy current loss by maintaining electrical insulation between the upper and lower non-oriented electrical steel sheets when the non-oriented electrical steel sheets are stacked in a plurality.

In the following, the present disclosure will be described in greater detail through embodiments according to the present disclosure and comparative examples not according to the present application, but the scope of the present disclosure is not limited by the embodiments presented below.

### Embodiment 1

### Manufacture of Non-Oriented Electrical Steel Sheet

A slab was manufactured by steelmaking and continuous casting with the components shown in Table 1 below, along with the balance Fe and other unavoidable impurities, reheated at a temperature of 1130 °C, and then hot-rolled with a finishing temperature of 880 °C, thereby manufacturing a hot-rolled steel sheet with a thickness of 2.0 mm.

Thereafter, the hot-rolled steel sheet was coiled at a coiling temperature of 600 °C.

Thereafter, the hot-rolled steel sheet was pre-annealed by heating it to 1000 °C at a heating rate of 20 °C/s in an atmosphere of 100% nitrogen, holding it at this temperature for 100 seconds, and then cooling it at a cooling rate of 30 °C/s.

Thereafter, the pre-annealed hot-rolled steel sheet was cold-rolled with a reduction ratio of 87.5%, thereby manufacturing a cold-rolled steel sheet with a thickness of 0.25 mm.

Thereafter, the cold-rolled steel sheet was heated to 1000 °C at a heating rate of 20 °C/s in an atmosphere of 30% hydrogen and 70% nitrogen, held at this temperature for 60 seconds, then cooled at a cooling rate of 30 °C/s, and final annealed, thereby manufacturing a non-oriented electrical steel sheet.

TABLE 1
Slab composition (wt %)

| Si | Mn | Al | C | P | S | N | Ti | B | Ce |
|---|---|---|---|---|---|---|---|---|---|
| 3.3 | 0.2053 | 0.9025 | 0.0020 | 0.01 | 0.0018 | 0.0012 | 0.0013 | 0.012 | 0.0075 |

### Embodiments 2 to 8 and Comparative Examples 1 to 7

### Manufacture of Non-Oriented Electrical Steel Sheets

Non-oriented electrical steel sheets were manufactured in the same method as in Embodiment 1, except that the contents of boron (B) and cerium (Ce) in the slab composition were modified as shown in Table 2 below.

TABLE 2

Slab composition (wt %)

| | B | Ce |
|---|---|---|
| Embodiment 2 | 0.011 | 0.0053 |
| Embodiment 3 | 0.0023 | 0.0137 |
| Embodiment 4 | 0.001 | 0.0145 |
| Embodiment 5 | 0.01 | 0.002 |
| Embodiment 6 | 0.0087 | 0.0018 |
| Embodiment 7 | 0.0023 | 0.0049 |
| Embodiment 8 | 0.002 | 0.0012 |
| Comparative | 0.02 | 0.04 |
| Example 1 | | |
| Comparative | 0.018 | 0.039 |
| Example 2 | | |
| Comparative | 0.035 | 0.008 |
| Example 3 | | |
| Comparative | 0.008 | 0.027 |
| Example 4 | | |
| Comparative | 0.011 | 0.01 |
| Example 5 | | |
| Comparative | 0.0195 | — |
| Example 6 | | |
| Comparative | — | 0.0195 |
| Example 7 | | |

### Embodiments 9 to 12 and Comparative Examples 8 to 12

### Manufacture of Non-Oriented Electrical Steel Sheets

Non-oriented electrical steel sheets were manufactured in the same method as in Embodiment 1, except that the pre-annealing conditions for the hot-rolled steel sheets were modified as shown in Table 3 below. In this case, Comparative Example 8 did not undergo pre-annealing.

TABLE 3

| | | | Holding | | |
|---|---|---|---|---|---|
| | Atmo- | Heating | temper- | | Cooling |
| | sphere | rate | ature | Holding | rate |
| | (%) | (°C/s) | (°C) | time (s) | (°C/s) |
| Embodiment 9 | Nitrogen 100 | 35 | 1050 | 75 | 75 |
| Embodiment 10 | Nitrogen 100 | 55 | 1000 | 95 | 45 |
| Embodiment 11 | Nitrogen 100 | 65 | 1030 | 85 | 65 |
| Embodiment 12 | Nitrogen 100 | 85 | 980 | 105 | 30 |
| Comparative | — | — | — | — | — |
| Example 8 | | | | | |
| Comparative | Nitrogen 100 | 25 | 850 | 130 | 8 |
| Example 9 | | | | | |
| Comparative | Nitrogen 100 | 20 | 823 | 150 | 10 |
| Example 10 | | | | | |
| Comparative | Nitrogen 100 | 10 | 750 | 180 | 20 |
| Example 11 | | | | | |
| Comparative | Nitrogen 100 | 8 | 700 | 210 | 25 |
| Example 12 | | | | | |

### Evaluation Example 1. Evaluation of Crystallographic Texture

The orientations of the crystallographic texture were measured over an area of 1000 μm×1000 μm or greater using electron backscatter diffraction (EBSD) for the non-oriented electrical steel sheets manufactured in each of the embodiments and comparative examples, a, b, and c as represented in General Formula 1 below were then determined via the orientation distribution function (ODF) for the measured crystallographic texture orientations, and based on these results, calculations were performed by General Formula 1 below and are presented in Table 4.

$$5 \leq \frac{1.5 \times a + 3 \times b}{0.5 \times c} \qquad [ General Formula 1 ]$$

In General Formula 1 above, a is the maximum intensity (f(g)ₘₐₓ) of the orientation distribution function in the crystallographic texture appearing at Euler angles (φ₁, Φ, φ₂) where φ₁ is 15° or greater and 35° or less, Φ is 0° or greater and 35° or less, and φ₂ is 45°, b is the maximum intensity (f(g)ₘₐₓ) of the orientation distribution function in the crystallographic texture appearing at Euler angles (φ₁, Φ, φ₂) where φ₁ is 55° or greater and 75° or less, Φ is 0° or greater and 20° or less, and φ₂ is 45°, and c is the maximum intensity (f(g)ₘₐₓ) of the orientation distribution function in the crystallographic texture appearing at Euler angles (φ₁, Φ, φ₂) where 1 is 15° or greater and 35° or less, Φ is greater than 35° and 60° or less, and φ₂ is 45°.

### Evaluation Example 2. Evaluation of Iron Loss and Magnetic Flux Density

A coating layer was formed by applying a chromium-free (Cr-free) coating solution to the surface of the non-oriented electrical steel sheet manufactured in each of the embodiments and comparative examples, heating it to 300 °C, and then slowly cooling and drying it, the non-oriented electrical steel sheets with the coating layer formed on their surfaces were then punched to 60 mm in width by 60 mm in length, respectively, the magnetic properties were measured at angles of 0° and 90° relative to the rolling direction during cold rolling via a Single Sheet Tester, and their average values are presented in Table 4 below. In this case, the W_{10/400} refers to the iron loss when a magnetic flux density of 1.0 Tis induced at a high frequency of 400 Hz. Further, the B₅₀ refers to the magnetic flux density induced in a magnetic field of 5000 A/m.

### Evaluation Example 3. Evaluation of Grain Size

When manufacturing non-oriented electrical steel sheets in each of the embodiments and comparative examples, the average grain size formed in the hot-rolled steel sheets during the pre-annealing process was measured in accordance with the ASTM E112 standard, and the results are presented in Table 4 below.

TABLE 4

| | | | | Value calculated | Average grain size | | |
|---|---|---|---|---|---|---|---|
| | | | | by General | during pre- | W_{10/400} | B₅₀ |
| | a | b | c | Formula 1 | annealing (μm) | (W/kg) | (T) |
| Embodiment 1 | 5.3 | 4.7 | 8.2 | 5.4 | 201 | 12.51 | 1.65 |
| Embodiment 2 | 4.6 | 3.8 | 5 | 7.3 | 238 | 12.46 | 1.66 |
| Embodiment 3 | 5.1 | 3.7 | 4.8 | 7.8 | 210 | 12.43 | 1.66 |
| Embodiment 4 | 4.4 | 3.2 | 3.7 | 8.8 | 116 | 12.17 | 1.67 |
| Embodiment 5 | 6 | 4.4 | 4.7 | 9.4 | 150 | 12.02 | 1.67 |
| Embodiment 6 | 4.5 | 4.3 | 4 | 9.8 | 134 | 11.85 | 1.67 |
| Embodiment 7 | 5.8 | 4.9 | 4.1 | 11.4 | 189 | 11.44 | 1.65 |
| Embodiment 8 | 6.3 | 6.3 | 4.6 | 12.3 | 176 | 10.89 | 1.68 |
| Embodiment 9 | 5.1 | 4.8 | 8.5 | 5.2 | 115 | 12.83 | 1.64 |
| Embodiment 10 | 5.4 | 4.1 | 8.0 | 5.5 | 158 | 12.77 | 1.64 |
| Embodiment 11 | 5.3 | 4.7 | 8.2 | 5.4 | 201 | 12.51 | 1.64 |
| Embodiment 12 | 5.5 | 4.2 | 8.1 | 5.1 | 241 | 12.83 | 1.64 |
| Comparative | 2.1 | 1.1 | 14.1 | 0.9 | 183 | 15.56 | 1.60 |
| Example 1 | | | | | | | |
| Comparative | 3.2 | 3 | 13.5 | 2.0 | 125 | 15.12 | 1.64 |
| Example 2 | | | | | | | |
| Comparative | 3.5 | 3.2 | 11.2 | 2.7 | 195 | 14.57 | 1.63 |
| Example 3 | | | | | | | |
| Comparative | 4.1 | 3.8 | 9.5 | 3.7 | 232 | 14.12 | 1.59 |
| Example 4 | | | | | | | |
| Comparative | 4.3 | 4.2 | 8.7 | 4.4 | 112 | 13.89 | 1.61 |
| Example 5 | | | | | | | |
| Comparative | 4.4 | 3.2 | 9.3 | 3.5 | 135 | 14.32 | 1.62 |
| Example 6 | | | | | | | |
| Comparative | 4.1 | 3.7 | 8.8 | 3.9 | 185 | 14.88 | 1.61 |
| Example 7 | | | | | | | |
| Comparative | 0.8 | 1 | 20.5 | 0.4 | Immeasurable | 15.78 | 1.61 |
| Example 8 | | | | | | | |
| Comparative | 1.3 | 1.8 | 18.8 | 0.8 | 33 | 14.23 | 1.62 |
| Example 9 | | | | | | | |
| Comparative | 1.5 | 2.6 | 15.8 | 1.3 | 85 | 13.44 | 1.63 |
| Example 10 | | | | | | | |
| Comparative | 4.3 | 6.1 | 7.2 | 6.9 | 275 | 13.85 | 1.63 |
| Example 11 | | | | | | | |
| Comparative | 4.1 | 5.8 | 7.5 | 6.3 | 337 | 14.31 | 1.63 |
| Example 12 | | | | | | | |

As shown in Tables 3 and 4 above, it was confirmed that the non-oriented electrical steel sheets manufactured in each of Embodiments 1 to 12 exhibited low iron loss and high magnetic flux density, as they satisfied General Formula 1 and the average grain size formed in the hot-rolled steel sheet during the pre-annealing process when manufacturing the non-oriented electrical steel sheets satisfied a particular range. In contrast, it was confirmed that since the non-oriented electrical steel sheets manufactured in each of Comparative Examples 1 to 5 failed to satisfy General Formula 1, it was difficult to simultaneously achieve both low iron loss and high magnetic flux density even if the average grain size formed in the hot-rolled steel sheet during the pre-annealing process when manufacturing the non-oriented electrical steel sheets satisfied the particular range. Further, it was confirmed that the non-oriented electrical steel sheets manufactured in each of Comparative Examples 6 to 12 exhibited high iron loss and low magnetic flux density, as they failed to satisfy General Formula 1 and the average grain size formed in the hot-rolled steel sheet during the pre-annealing process when manufacturing the non-oriented electrical steel sheets failed to satisfy the particular range.

What is claimed:

1. A non-oriented electrical steel sheet comprising, in weight percent: Si at 1.8% or greater and 3.8% or less; Mn at 0.2% or greater and 0.4% or less; Al at 0.8% or greater and 1.5% or less; B at greater than 0% and less than 0.02%; and Ce at greater than 0% and less than 0.02%, with the balance being Fe and unavoidable impurities,
and satisfying General Formula 1 below:
$$5 \leq \frac{1.5 \times a + 3 \times b}{0.5 \times c} , \qquad [ General Formula 1 ]$$
in General Formula 1 above, a is a maximum intensity (f(g)ₘₐₓ) of an orientation distribution function in a crystallographic texture appearing at Euler angles (φ₁, Φ, φ₂) where φ₁ is 15° or greater and 35° or less, Φ is 0° or greater and 35° or less, and φ₂ is 45°,
b is a maximum intensity (f(g)ₘₐₓ) of an orientation distribution function in a crystallographic texture appearing at Euler angles (φ₁, Φ, φ₂) where φ₁ is 55° or greater and 75° or less, Φ is 0° or greater and 20° or less, and φ₂ is 45°, and
c is a maximum intensity (f(g)ₘₐₓ) of an orientation distribution function in a crystallographic texture appearing at Euler angles (φ₁, Φ, φ₂) where φ₁ is 15° or greater and 35° or less, Φ is greater than 35° and 60° or less, and φ₂ is 45°.

2. The non-oriented electrical steel sheet of claim 1, wherein the maximum intensity (f(g)ₘₐₓ) of the orientation distribution function in the crystallographic texture appearing at Euler angles (φ₁, Φ, φ₂) where φ₁ is 15° or greater and 35° or less, Φ is 0° or greater and 35° or less, and φ₂ is 45° is 4.4 or greater and 7.0 or less.

3. The non-oriented electrical steel sheet of claim 1, wherein an orientation (g) of the crystallographic texture having the maximum intensity (f(g)ₘₐₓ) of the orientation distribution function in the crystallographic texture appearing at Euler angles (φ₁, Φ, φ₂) where φ₁ is 15° or greater and 35° or less, Φ is 0° or greater and 35° or less, and φ₂ is 45° is a {113}<251> orientation.

4. The non-oriented electrical steel sheet of claim 1, wherein the maximum intensity (f(g)ₘₐₓ) of the orientation distribution function in the crystallographic texture appearing at Euler angles (φ₁, Φ, φ₂) where φ₁ is 55° or greater and 75° or less, Φ is 0° or greater and 20° or less, and φ₂ is 45° is 3.0 or greater and 7.0 or less.

5. The non-oriented electrical steel sheet of claim 1, wherein an orientation (g) of the crystallographic texture having the maximum intensity (f(g)ₘₐₓ) of the orientation distribution function in the crystallographic texture appearing at Euler angles (φ₁, Φ, φ₂) where φ₁ is 55° or greater and 75° or less, Φ is 0° or greater and 20° or less, and φ₂ is 45° is a {100}<130> orientation.

6. The non-oriented electrical steel sheet of claim 1, wherein the maximum intensity (f(g)ₘₐₓ) of the orientation distribution function in the crystallographic texture appearing at Euler angles (φ₁, Φ, φ₂) where φ₁ is 15° or greater and 35° or less, Φ is greater than 35° and 60° or less, and φ₂ is 45° is 3.0 or greater and 8.5 or less.

7. The non-oriented electrical steel sheet of claim 1, wherein an orientation (g) of the crystallographic texture having the maximum intensity (f(g)ₘₐₓ) of the orientation distribution function in the crystallographic texture appearing at Euler angles (φ₁, Φ, φ₂) where φ₁ is 15° or greater and 35° or less, Φ is greater than 35° and 60° or less, and φ₂ is 45° is a {334}<483> orientation.

8. The non-oriented electrical steel sheet of claim 1, wherein a total content of B and Ce is greater than 0% and 0.02% or less by weight.

9. The non-oriented electrical steel sheet of claim 1, further comprising one or more selected from:
C at greater than 0% and 0.002% or less; P at greater than 0% and 0.015% or less; S at greater than 0% and 0.002% or less; N at greater than 0% and 0.002% or less; and Ti at greater than 0% and 0.002% or less, in weight percent.

10. The non-oriented electrical steel sheet of claim 1, wherein an average of iron loss W_{10/400} measured at angles of 0° and 90° with respect to a rolling direction during cold rolling is 13.00 W/kg or less, and an average of magnetic flux density (B₅₀) is 1.64 T or greater.

11. A method of manufacturing a non-oriented electrical steel sheet, comprising the steps of:
reheating and then hot-rolling a slab comprising, in weight percent: Si at 1.8% or greater and 3.8% or less; Mn at 0.2% or greater and 0.4% or less; Al at 0.8% or greater and 1.5% or less; B at greater than 0% and less than 0.02%; and Ce at greater than 0% and less than 0.02%, with the balance being Fe and unavoidable impurities;
manufacturing a cold-rolled steel sheet by cold-rolling; and
final annealing the cold-rolled steel sheet,
wherein the final annealed steel sheet satisfies General Formula 1 below:
$$5 \leq \frac{1.5 \times a + 3 \times b}{0.5 \times c} , \qquad [ General Formula 1 ]$$
in General Formula 1 above, a is a maximum intensity (f(g)ₘₐₓ) of an orientation distribution function in a crystallographic texture appearing at Euler angles (φ₁, Φ, φ₂) where φ₁ is 15° or greater and 35° or less, Φ is 0° or greater and 35° or less, and φ₂ is 45°,
b is a maximum intensity (f(g)ₘₐₓ) of an orientation distribution function in a crystallographic texture appearing at Euler angles (φ₁, Φ, φ₂) where φ₁ is 55° or greater and 75° or less, Φ is 0° or greater and 20° or less, and φ₂ is 45°, and
c is a maximum intensity (f(g)ₘₐₓ) of an orientation distribution function in a crystallographic texture appearing at Euler angles (φ₁, Φ, φ₂) where φ₁ is 15° or greater and 35° or less, Φ is greater than 35° and 60° or less, and φ₂ is 45°.

12. The method of claim 11, wherein the maximum intensity (f(g)ₘₐₓ) of the orientation distribution function in the crystallographic texture appearing at Euler angles (φ₁, Φ, φ₂) where φ₁ is 15° or greater and 35° or less, Φ is 0° or greater and 35° or less, and φ₂ is 45° in the final annealed steel sheet is 4.4 or greater and 7.0 or less.

13. The method of claim 11, wherein the maximum intensity (f(g)ₘₐₓ) of the orientation distribution function in the crystallographic texture appearing at Euler angles (φ₁, Φ, φ₂) where φ₁ is 55° or greater and 75° or less, Φ is 0° or greater and 20° or less, and φ₂ is 45° in the final annealed steel sheet is 3.0 or greater and 7.0 or less.

14. The method of claim 11, wherein the maximum intensity (f(g)ₘₐₓ) of the orientation distribution function in the crystallographic texture appearing at Euler angles (φ₁, Φ, φ₂) where φ₁ is 15° or greater and 35° or less, Φ is greater than 35° and 60° or less, and φ₂ is 45° in the final annealed steel sheet is 3.0 or greater and 8.5 or less.

15. The method of claim 11, wherein the slab has a total content of B and Ce of greater than 0% and 0.02% or less in weight percent.

16. The method of claim 11, wherein the slab further comprises one or more selected from: C at greater than 0% and 0.002% or less; P at greater than 0% and 0.015% or less; S at greater than 0% and 0.002% or less; N at greater than 0% and 0.002% or less; and Ti at greater than 0% and 0.002% or less, in weight percent.

17. The method of claim 11, further comprising a step of pre-annealing the hot-rolled steel sheet that has been hot-rolled through the step of hot-rolling,
wherein the step of pre-annealing is performed by heating the hot-rolled steel sheet to 900 °C or greater and 1100 °C or less at a heating rate of 20 °C/s or greater.

18. The method of claim 17, wherein the hot-rolled steel sheet has an average grain size of 100 μm or greater and 250 μm or less during the pre-annealing process.
